(19) United States
(12) Patent Application Publication
(10) Pub. No.: US 2007/0286139 A1
(43) Pub. Date: Dec. 13, 2007

(54) Methods of routing data within a wireless communication system

(75) Inventors: Zhisheng Niu, Beijing (CN); Ling Qian, Beijing (CN); Lei Wang, Vancouver, WA (US); Zhi Zheng, Beijing (CN)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/702,628

(22) Filed: Feb. 6, 2007

(30) Foreign Application Priority Data
Jun. 9, 2006 (CN) 200610091682.7

(51) Int. Cl. H04Q 7/24

(52) U.S. Cl. 370/338

(57) ABSTRACT

Methods of routing data within a wireless communication system are provided. In the example methods and system, data packets may be routed to and/or between any node within a Mobile Ad-Hoc Network (MANET), such as a network running Ad-hoc On-demand Distance Vector (AODV) protocol, and an external connection or device (e.g., an Internet entity) if at least one node within the MANET includes a connection to the external connection or device. Accordingly, a single “connected” MANET node may share its external connections with non-connected nodes.

### PRIORITY STATEMENT

This application claims priority under 35 U.S.C. §119 to Chinese Patent Application No. 200610091682.7, filed Jun. 9, 2006, in the Chinese Patent Office (CPO), the disclosure of which is incorporated herein in its entirety by reference.

### BCKGROUND OF THE INVENTION

1. Field of the Invention

Example embodiments of the present invention relate generally to methods of routing data, and, more particularly, to methods of routing data between Internet connected entities and non-Internet connected nodes.

2. Description of the Related Art

Mobile Ad-Hoc Network (MANET) routing protocols relate to protocols for routing messages between mobile devices. An example of a MANET routing protocol is the Ad-hoc On-demand Distance Vector (AODV) protocol. AODV allows these mobile devices, or nodes, to pass messages through their neighbors to nodes with which they cannot directly communicate. AODV does this by discovering the route(s) along which messages can be passed. AODV makes sure these routes do not contain loops (e.g., one or more nodes which repeat) and tries to find the shortest route possible (e.g., based on delay, a number of visited nodes or hops, etc.). AODV is also able to handle changes in routes and can create new routes if there is an error.

FIG. 1 illustrates a conventional AODV network 100. As shown in FIG. 1, the AODV network 100 includes nodes 1, 2, 3, 4 and 5 with coverage areas 105, 110, 115, 120 and 125, respectively. Nodes which can communicate directly with other nodes are referred to as “neighbors”.

Each node in the AODV network 100 keeps track of its neighbors by listening for “HELLO” messages that every node broadcasts at fixed, periodic intervals. When a given node desires to send a message to a non-neighbor node, the node broadcasts a Route Request (RREQ) message. The RREQ message includes a source identifier identifying the node sending the RREQ message, a destination identifier identifying the non-neighbor node to which the message is addressed, a lifespan of the message, a hop count of the message and a Sequence Number serving as a unique identifier for the message. The lifespan indicates a duration that the message is “active”, after which no attempts to transfer the message to the destination non-neighbor node will be performed by any node. The hop count indicates a current number of hops taken by the message from its origin. The hop count may be incremented (e.g., by 1) after each hop.

FIG. 2 illustrates a conventional message routing process within the AODV network 100 of FIG. 1. In step S200, node 1 determines to send a message to node 3. As shown in FIG. 1, node 1's neighbors are nodes 2 and 4. Therefore, node 1 cannot directly communicate with node 3. Node 1 broadcasts a RREQ, which is received by node 4 and node 2. In this example, for the sake of simplicity, the destination identifier is “3” (i.e., to designate node 3), the source identifier is “1 ” (i.e., to designate node 1), the Lifespan is “3” (e.g., to designate a time duration, which, by default, may be 255 hops), the initial Hop Count is “0” (e.g., this value may be incremented by 1 at each successive hop in order to gather the hop measure to destination) and the Sequence Number is “0”. Thus, the RREQ sent by the node 1 may be expressed as [Destination identifier, Source identifier, Lifespan, Hop Count, Sequence Number] or [3, 1, 3, 0, 0].

The RREQ [3, 1, 3, 0, 0] is received by each of neighbor nodes 2 and 4. In steps S205 and S210, nodes 4 and 2, respectively, determine whether the destination identifier identifies a node that is (i) known by nodes 4 or 2, respectively or (ii) whether the receiving node (e.g., node 2 or 4) is identified by the destination identifier. If each of conditions (i) and (ii) are not met, the receiving node rebroadcasts the received RREQ if the lifespan has not expired. Accordingly, in step S205, since node 4 is not node 3's neighbor and node 4 is not node 3, node 4 rebroadcasts the RREQ, which is received by node 5. It is understood that because node 1 is node 4's neighbor, node 1 would also receive the RREQ, but because node 1 is the original sending node, this step has not been illustrated because the receipt of the rebroadcast RREQ would be ignored by node 1. Also, while not shown, step S205, performed at node 4, would then be performed at node 5 after receiving the rebroadcast RREQ from node 4, and so on.

Returning to step S210, node 2 is a neighbor of node 3 and therefore knows the route to node 3. Node 2 then determines whether node 2 is the node identified by the destination identifier. Because node 2 is not the destination entity, node 2 sends a Route Reply (RREP) back to the node 1 to indicate that a route to node 3 has been found and, node 2 may also generate and unicast a gratuitous RREP to node 3 if node 1 wants to create a bi-directional route with node 3; otherwise, node 3 won't know the route back to node 1. Alternatively, if node 1 does not want any intermediate node to send RREP, node 2 will simply rebroadcast the RREQ until an RREP is received from the actual destination. RREPs are similar to RREQS, but RREPs include a the lifespan to indicate the valid time-duration of the route. In addition, the hop count in RREP indicates the actual hops to the destination.

Node 3 receives the rebroadcast RREQ and determines whether conditions (i) and (ii) are met in step S215. Because condition (ii) is met (i.e., node 3 is the node identified by the destination identifier), node 3 sends a RREP to node 1 through node 2 and does not rebroadcast the RREQ. Typically, node 1 will only receive one (1) RREP in response to its broadcasted RREQ, which can be configured to either be sent from an intermediate node (e.g., node 2 or the first node receiving the RREQ which knows the location of the destination node) or the destination node itself.

Node 1 receives the RREP and determines, based on the RREP's Sequence Number, whether to update a routing path to node 3. Sequence numbers serve as time stamps by allowing nodes to determine how “fresh” their information is with respect to other nodes. Each time a node sends a new message, the Sequence Number associated with the new message is incremented from a previously sent message. Each node records the current (i.e., highest) Sequence Number of the nodes it talks to. Higher Sequence Numbers indicate “fresher” or more up-to-date routes.

Once a routing path from a source node to a destination node is known, the source node sends data to the destination node until a Route Error Message (RERR) is received. The RERR indicates a broken link in one or more routing paths between the source node and the destination node. Whenever a node receives a RERR, the node examines its Routing Table and removes all the routes that contain the “bad” nodes (i.e., the nodes to which the source nodes are no longer connected, at least through the old routing path).

Generally, a RERR is broadcast in response to three (3) situations. In a first scenario, a node receives a data packet for forwarding but does not have a routing path to the data packet's destination. Thus, another node (i.e., sending the data packet) erroneously thinks a correct routing path to the destination node is through the node not knowing the destination.

In a second scenario, a node receives a RERR that causes at least one of its routes to become invalidated. The node sends out a RERR with all the new nodes which are now unreachable. In a third scenario, the node detects that it cannot communicate with one of its neighbors. The node updates its routing table to invalidate routes using the unreachable neighbor as a first hop. Then, the node sends out a RERR indicating the neighbor is not connected, which invalidates those associated routing paths.

Most communication devices functioning as hosts are controlled by operating systems (OSs) (e.g., open source operating systems such as Linux, non-open source OSs such as Windows®, etc.), which employ table-driven routing mechanisms. Table-driven routing mechanisms typically flood routing requests to neighbors, store feedback in tables in local memory and perform intensive processing on the local table data to determine routing paths. Also, a majority of software applications are increasingly being programmed for use with table-driven routing mechanisms. Mobile communication devices with limited memory capacity and/or power storage, which are typically included within AODV networks, may not be able to perform the processing intensive table-driven routing mechanism.

A few conventional techniques have been attempted, which employ features of both AODV protocols and table-driven routing mechanisms. Kernel mode AODV is configured for use with open-source OSs such as Linux. Typically, a program module is loaded onto a computer system controlled by the Linux OS. The loaded program module may make changes to the Linux OS source code in order to implement AODV routing. However, kernel mode AODV is only available within open-source systems, and cannot be implemented on systems executing a non-open-source OS such as Windows® (e.g., Windows® 95, 98,ME, 2000, NT, XP, Vista, etc.) because the lower-level network stack of the OS, which is only configurable on open-source systems, needs to be modified to support AODV routing protocols in kernel mode.

Another conventional alternative is user-mode AODV. Generally, user mode AODV includes executing AODV routing protocols at higher levels than the kernel mode or OS level. For example, a program module written in any well-known executable programming language (e.g., Java, C++, etc.) may be compiled and run by the host node. User-mode AODV, unlike kernel mode AODV, is executed at a higher level and may thereby be adapted for use in either open-source or non-open-source OSs. However, user-mode AODV is typically associated with increased processing requirements as well as increased latency.

FIG. 3 illustrates a conventional user mode AODV network message routing process. In the below description of the conventional process of FIG. 3, the AODV network 100 is described as being a user mode AODV network.

In step S300, the user mode AODV network 100 sets a media access control (MAC) address of a default gateway to zero or 00-00-00-00-00. The default gateway is a node to which a packet is sent by “default” if another address is not specified by the packet. A source node determines whether to send a packet to a destination node in step S305. If the source node determines not to send a packet, the process waits at step S305 until the source node wishes to send a packet. Otherwise, if the source node determines to send a packet to the destination node, the process advances to step S310.

In step S310, the source node sends the packet to the default gateway by setting the MAC address of the packet to all zeroes, thereby identifying the default gateway. The default gateway receives and analyzes the packet in step S315 to determine the actual destination node to which the packet is to be sent. After determining the destination node, in step S320, the default gateway executes an AODV route discovery procedure, for example, the process described above with respect to FIG. 2, to determine a routing path from the default gateway to the destination node. The AODV route discovery procedure of step S320 only searches potential routing paths to destination nodes within the user mode AODV network 100. Once a suitable routing path is discovered, in step S325, the default gateway sends the packet to the destination node along a discovered routing path.

As discussed above, conventional kernel mode AODV may only be employed by open-source OSs. Conventional user mode AODV is more flexible than kernel mode AODV, but performs less well and is associated with increased processing requirements. Also, neither kernel mode AODV nor user mode AODV is capable of performing routing of “out-of-network” data packets (e.g., data packets sent from an AODV node without an Internet connection to an Internet destination, data packets sent from an Internet source entity to an AODV node without an Internet connection, etc.), and is thereby limited to routing to nodes within the AODV network 100 as described above with respect to FIGS. 1 to 3.

### SUMMARY OF THE INVENTION

An example embodiment of the present invention is directed to a method of routing data, including receiving a data packet at a communication node, the communication node including connections to an Internet and at least one other communication node not connected the Internet, each of the communication node and the at least one other communication node included within a same Mobile Ad-Hoc Network (MANET), determining whether the data packet is configured to be sent to one of the Internet and the at least one other communication node and sending the data packet to one of the Internet and the at least one other communication node based on the determining step.

Another example embodiment of the present invention is directed to a method of routing data from a source node without an Internet connection to an Internet destination entity, including sending a data packet from the source node to a gateway node having an Internet connection, the source node and the gateway node within a same MANET, the data packet including instructions instructing the gateway node to forward the data packet to the Internet destination entity through the Internet connection.

Another example embodiment of the present invention is directed to a method of routing data from an Internet source entity to a destination node without an Internet connection, including sending a data packet to a gateway node having an Internet connection and connected to the destination node, the gateway node and the destination node within a same MANET, the data packet including instructions instructing the gateway node to forward the data packet to the destination node.

Another example embodiment of the present invention is directed to a wireless communication system, including an Internet connection connected to a plurality of communication networks and a MANET included among the plurality of communication networks, the MANET including at least one node connected to the Internet connection, the at least one node configured to route data packets between the plurality of communication networks and nodes within the MANET which are not connected to the Internet connection.

Another example embodiment of the present invention is directed to a method of routing data between a MANET and one or more other networks, including first assigning each node within the MANET an internal address and second assigning the MANET an external address, the external address distinguishing the MANET from the one or more other networks.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a conventional Ad-hoc On-demand Distance Vector (AODV) network.

FIG. 2 illustrates a conventional message routing process within the AODV network of FIG. 1.

FIG. 3 illustrates a conventional user mode AODV network message routing process.

FIG. 4 illustrates an AODV network according to an example embodiment of the present invention.

FIG. 5 illustrates an AODV message routing process according to an example embodiment of the present invention.

FIG. 6 illustrates a process for sending a data packet from a non-Internet connected AODV node within the AODV network of FIG. 4 to an Internet destination entity within an Internet according to another example embodiment of the present invention.

FIG. 7 illustrates a process for sending a data packet from an Internet destination entity within an Internet to a non-Internet connected AODV node within the AODV network of FIG. 4 according to another example embodiment of the present invention.

### DETAILED DESCRIPTION OF EXAMPLE EMBODIMENTS

As discussed in the Background of the Invention section, conventional Ad-hoc On-demand Distance Vector (AODV) networks may not be capable of routing a data packet from a AODV node without an Internet connection to an Internet destination entity, nor can a conventional Internet source entity send a data packet to an AODV node not directly connected to the Internet. Accordingly, example embodiments of the present invention, as will now be described, are directed to an addressing scheme which allows for a routing of Internet messaging to and/or from any desired AODV node(s) within an AODV network through an AODV node within the AODV network having an Internet connection.

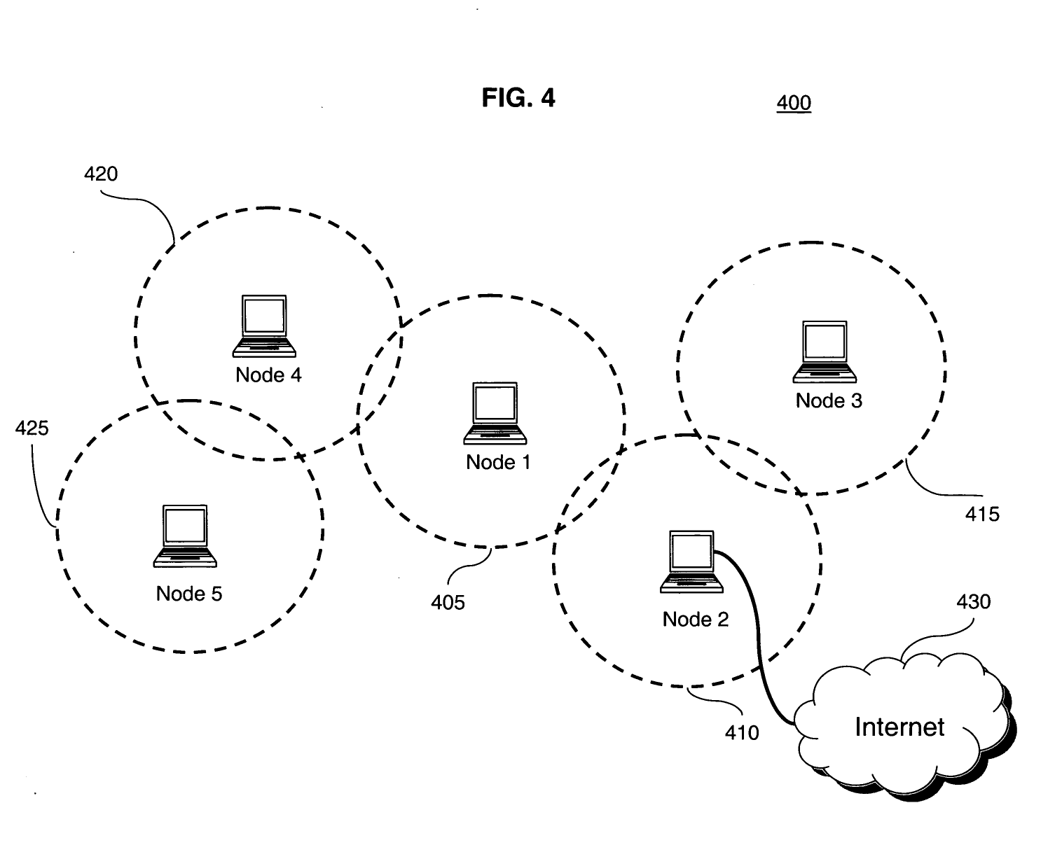

FIG. 4 illustrates an AODV network 400 according to an example embodiment of the present invention.

In the example embodiment of FIG. 4, AODV network 400 includes nodes 1, 2, 3, 4 and 5 with coverage areas 405, 410, 415, 420 and 425, respectively. Nodes which can communicate directly with other nodes are referred to as “neighbors”. Generally, the AODV network 400 is similar to the AODV network 100 except that node 2 in the AODV network 400 is further connected to an Internet 430 in addition to being in communication with neighbor nodes 1 and 3. The Internet 430 includes a plurality of communication networks, which may exchange data packets with any of a number of well-known protocols (e.g., TCP/IP protocols).

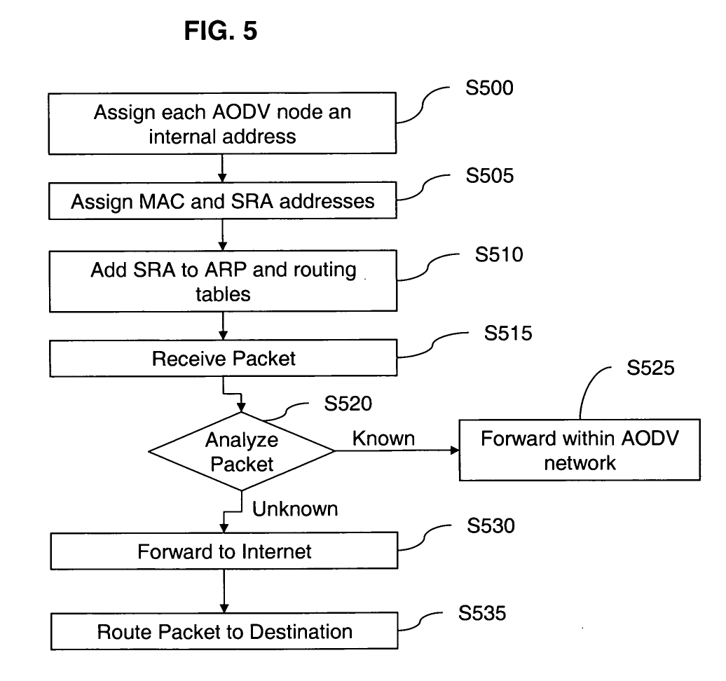

FIG. 5 illustrates an AODV message routing process according to an example embodiment of the present invention. The example AODV message routing process of FIG. 5 will be described below with reference to the AODV network 400 of FIG. 4. The operations described below are performed by node 2 (e.g., a node connected to the Internet 430) within the AODV network 400.

In step S500, each of nodes 1, 2, 3, 4 and 5 are assigned an internal address for use in routing within the AODV network 400. Table 1 (below) illustrates an example set of internal addresses for each of nodes 1 through 5.

TABLE 1

| Node # | Assigned Internal Address |
|---|---|
| 1 | 10.0.0.1 |
| 2 | 10.0.0.2 |
| 3 | 10.0.0.3 |
| 4 | 10.0.0.4 |
| 5 | 10.0.0.5 |

For example, referring to step S500 of FIG. 5, the internal addresses for nodes 1-5 may be assigned manually (e.g., by each respective node independently, by node 2, etc.) or automatically (e.g., via a Dynamic Host Configuration Protocol (DHCP protocol) configured for the AODV network 400 of FIG. 4).

After the internal addresses are assigned, a spoofing reserve address (SRA) is assigned to identify the AODV network 400 of FIG. 4 in step S505. The SRA serves to distinguish the AODV network 400 from other networks connected to the Internet 430, and may be used as a destination address to route data packets to one or more nodes within the AODV network 400. In this example, the SRA address for the AODV network 400 is 10.255.255.254, the MAC address for the AODV network 400 is 00-00-00-00-00 and the MAC/SRA addresses are “static” and do not change during operation.

After the SRA is assigned, the address resolution protocol (ARP) table and the system routing table are updated. The ARP table is stored at each node within the AODV network 400, and the system routing table is managed by the operating system (e.g. Windows® 2000 professional/server, XP, etc.). Each computer associated with the AODV network 400 and the Internet 430 includes a local system routing table. In a first example, referring to internal devices (e.g., a computer, a mobile phone, internal routers, etc.), the system routing table may only contain some route in the Intranet (e.g., and not to other networks). In an alternative example, referring to border routers (e.g. routers sit on the edge of a network), the system routing table may also include routes to other networks. In our example, all the nodes within the ad hoc network form a subnet, their system routing tables may only contain local routes; while the system routing table of gateway nodes may have non-local routes.

Accordingly, the system routing table may be used by the OS to determine how to route the data packets. At the same time, there is an AODV routing table which is used by AODV routing protocol. AODV nodes typically use AODV the routing table to update the system routing table. However, node 2 includes a module referred to as a network address translator (NAT). The NAT, which is not present in AODV nodes without Internet connectivity, is used to generate a temporary IP address and/or Transport layer port for internal nodes to communicate with external node, e.g. the web server on the Internet 430. The ARP is a TCP/IP protocol used to convert an IP address into a physical address, such as an Ethernet address. Generally, a node (e.g., node 2), wishing to obtain a physical address, broadcasts an ARP request onto the TCP/IP network (e.g., the Internet 430). The node on the network (e.g., the Internet 430) that has the address in the request then replies with its physical hardware address.

In step S510, the ARP table at each node within the AODV network 400 is updated to notify the OS of the MAC address of SRA with an entry as follows:

ARP Table Entry

| Internet Address | Physical Address | Type |
|---|---|---|
| 10.255.255.254 | 00-00-00-00-00 | static |

Also in step S510, the routing table at each node in the AODV network 400 is updated, to allow packets addressed for Internet destinations to be forwarded to the Internet 430, with an entry as follows:

Routing Table Entry

| Destination | Next Hop |
|---|---|
| 10.0.0.0/255.0.0.0 | 10.255.255.254 |

Node 2 receives a data packet in step S515. The data packet received at node 2 in step S515 may be either (i) sent from a node (e.g., node 1, 3, 4, etc., or may originate from node 2 itself) within the AODV network 400 and destined for another node within the AODV network 400; (ii) sent from a node (e.g., node 1, 3, 4, etc., or may originate from node 2 itself) within the AODV network 400 and destined for an internet destination within the Internet 430; or (iii) sent from an Internet source via the Internet 430 and destined for a node within the AODV network 400. Node 2 includes a data packet capture module configured to receive and analyze data packets received in accordance with any of (i), (ii) or (iii). The data packet includes a destination address field, which denotes the intended destination entity. In step S520, node 2 analyzes the data packet to determine whether the destination address indicated by the destination address field of the data packet is known to be within the AODV network 400

An example will now be given regarding how node 2 may determine whether the destination node indicated by the destination address is “known” to be within the AODV network 400. Each node in the AODV network 400 has a local IP address and subnet mask. The subnet mask is used to identify the local IP and the external IP address. For example, a computer may have the IP address 135.252.20.29, the subnet mask 255.255.255.0. Accordingly, an IP address such as 135.252.20.XXX may be used as a subnet IP, and can be reached directly, otherwise, a gateway will help to route the packet to destination. The IP address obtainment may be performed manual or automatically, as is well-known in the art.

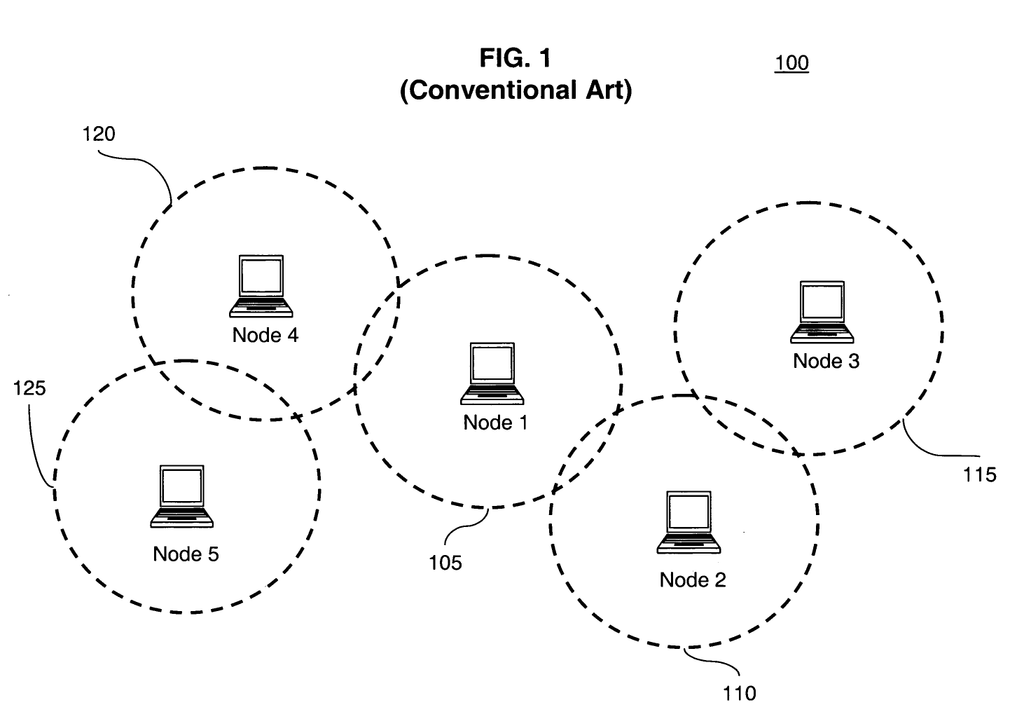

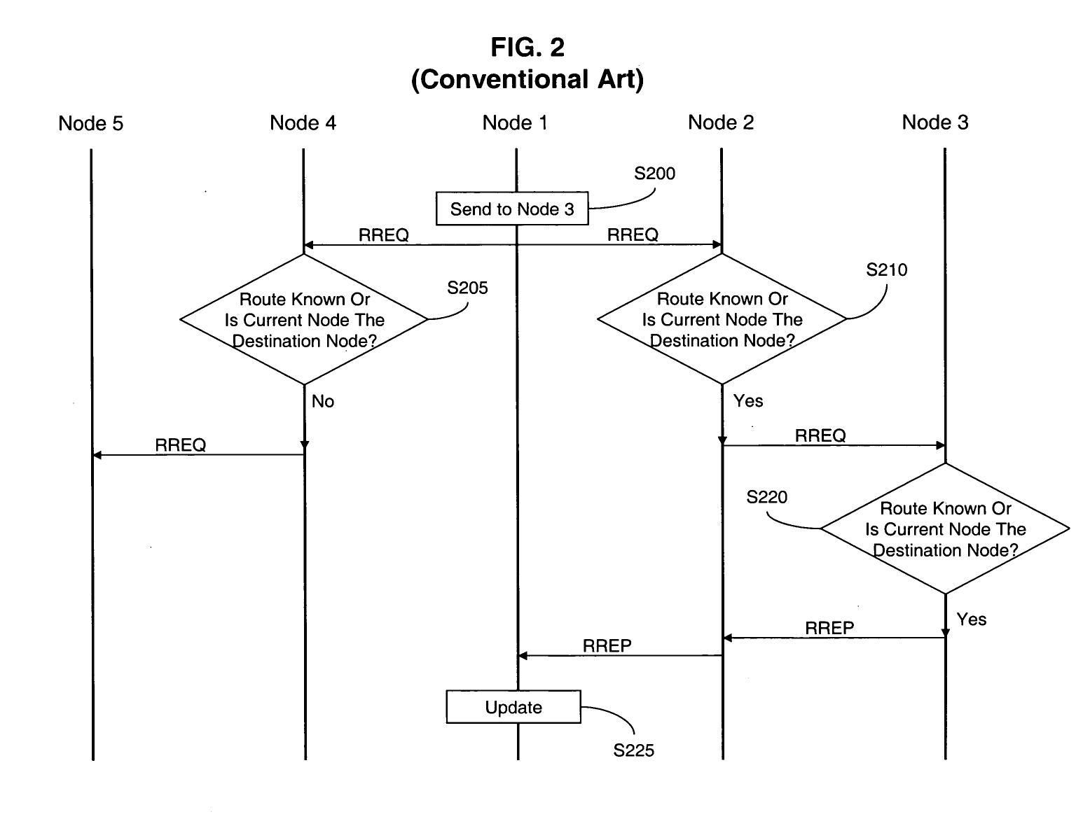

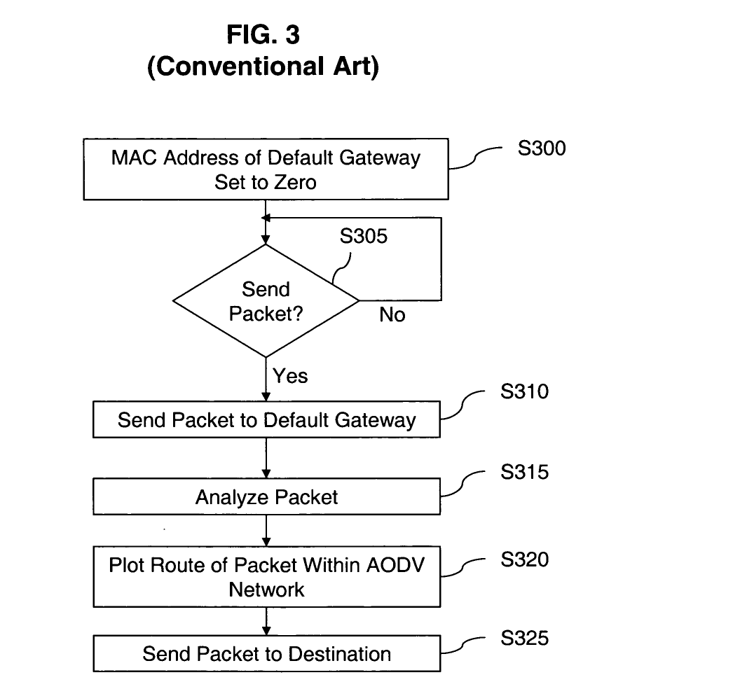

If the destination address is known to be with in the AODV network 400, node 2 forwards the data packet to the destination node using a conventional AODV routing process (e.g., see conventional FIGS. 1-3) in step S525. Otherwise, if the destination of the data packet is determined to be outside of the AODV network 400, the process advances to step S530.

In step S530, node 2 forwards the received data packet to the Internet 430. At this time, node 2 will not run the AODV route discovery procedure because the IP address is known to be an outside IP address and the data packet has already forwarded to node 2. If the destination of an incoming packets is within the Internet, the data packet is captured by the NAT module (e.g. which may be included within Windows® server) on node 2, which generates and assigns a temporary external IP address and/or transport layer port for the incoming packet. The packet is forwarded to the network interface (e.g. an ethernet card) connected to the Internet 430. If node 2 wants to send a packet to the Internet, the packet is processed in the same way as a incoming packet.

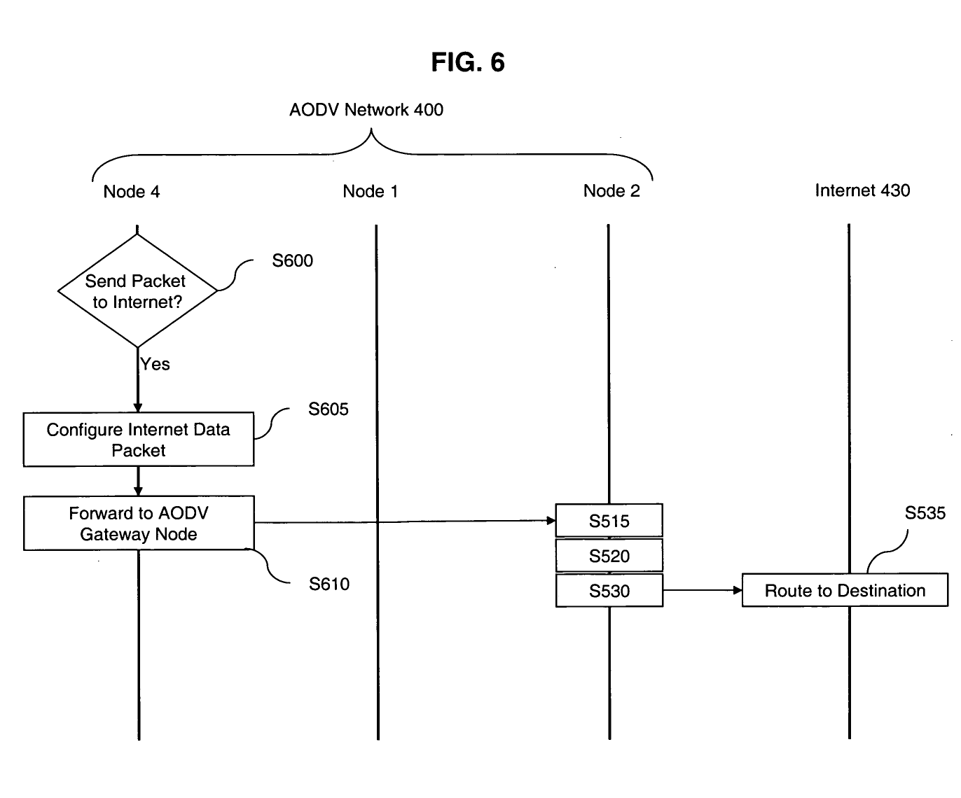

FIG. 6 illustrates a process for sending a data packet from a non-Internet connected AODV node within the AODV network 400 of FIG. 4 to an Internet destination entity within the Internet 430 according to another example embodiment of the present invention. In particular, the example given below with reference to FIG. 6 describes a data packet being sent from node 4 to the Internet 430. However, it is understood that other example embodiments of the present invention may employ similar techniques to send a data packet to the Internet 430 from any node within the AODV network 400.

In step S600, node 4 determines whether to send a data packet to a destination out-of-network with respect to the AODV network 400, such as an Internet destination entity within the Internet 430. If node 4 determines to send the data to an out-of-network destination, the process advances to step S605. If the AODV module captures packets which are destined to an external network (e.g., Internet 430), these packets are buffered. The AODV module initiates a gateway finding procedure to find the gateway to the external network. The gateway finding procedure is similar to the RREQ/RREP procedure with the exception that the destination IP address is set to 0.0.0.0, such that only the gateway can reply to the RREQ. After the gateway is found, node 4 will update the local routing table and forward the buffered packets.

In step S610, node 4 forwards the data packet to node 2 (e.g., after passing through intermediate node 1) using well-known “internal” AODV routing protocols, for example, those described above with respect to FIGS. 1 to 3.

Node 2 receives and processes the data packet in accordance with the above-described process of FIG. 5. Thus, the data packet is received from node 4 at node 2 in step S515, node 2 analyzes the data packet in step S520, and determines that the data packet is not intended for a node in the AODV network 400 in step S525. Node 2 forwards the data packet to the Internet 430 in step S530 (e.g., to a next-hop router in the Internet) and the Internet 430 routes the data packet to its intended destination in step S535 using well-known Internet data packet routing protocols.

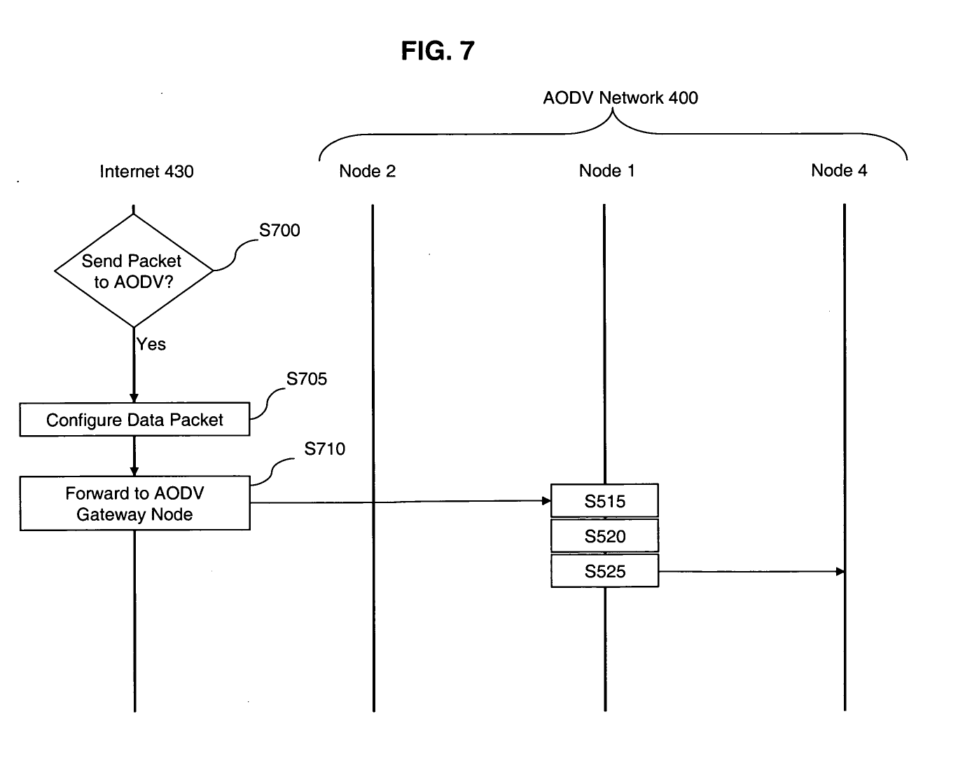

FIG. 7 illustrates a process for sending a data packet from an Internet destination entity within the Internet 430 to a non-Internet connected AODV node within the AODV network 400 of FIG. 4 according to another example embodiment of the present invention. In particular, the example given below with reference to FIG. 7 describes a data packet being sent from the Internet 430 to node 4 (e.g., a node not directly connected to the Internet 430). However, it is understood that other example embodiments of the present invention may employ similar techniques to send a data packet to any node within the AODV network 400 from the Internet 430.

In step S700, an Internet entity (e.g., a computer, a mobile telephone, etc.) connected to the Internet 430 determines whether to send or reply to a data packet to one or more nodes within the AODV network 400. In an example, the Internet entity may determine to send a data packet to the AODV network 400 in response to a request for information or other type of data packet received from one or more nodes within the AODV network 400. If the Internet entity determines to send the data packet to the AODV network 400 (e.g., in response to a request for information sent by one or more of the nodes within the AODV network 400), the Internet entity sends the data packet(s) to the gateway the same way as sending packet to any other destinations using well-known Internet routing protocols in step S705. Upon receiving the packet, the NAT module on node 2 captures the packet and routes the received packet to a designated destination AODV node. Accordingly, in step S710, (1) the data packet is routed to node 2 with well-known Internet routing protocols, (2) the routed data packet is processed by the NAT module at the node 2. The NAT module processing includes converting he IP address in the packet header to a corresponding AODV IP address (e.g. 10.0.0.4). The NAT IP address conversion table is generated when AODV node initiate the connection to the external network (e.g., Internet 430). Next, in step S710, (3) the OS at the Node 2 searches the system routing table and find the route to the destination node (e.g. node 4). This route is generated when node 4 initiate the gateway finding procedure.

Node 2 receives and processes the data packet in accordance with the above-described process of FIG. 5. Thus, the data packet is received from the Internet 430 at node 2 in step S515, node 2 analyzes the data packet in step S520, and determines that the data packet is intended to be sent to a node in the AODV network 400 in step S525. Node 2 forwards the data packet to node 4 (e.g., through intermediate node 1) in step S525 using well-known “internal” AODV routing protocols, as described above in conventional FIGS. 1 to 3.

Accordingly, it will be appreciated that AODV nodes without direct Internet connections may effectively become Internet-connected (e.g., for uploads of data packets to the Internet and/or downloads of data packets from the Internet), so long as at least one node within an AODV network has an Internet connection, with the above-described example AODV routing protocols.

Example embodiments of the present invention being thus described, it will be obvious that the same may be varied in many ways. For example, while particular AODV internal addresses (e.g., 10.0.0.1, 10.0.0.2, etc.), subnet masks (e.g. 255.255.255.0), IP addresses (e.g., 10.255.255.254) and MAC addresses (e.g., 00-40-96-54-CF-|OCi|) are given above, it is understood that these are intended to represent examples only and other example embodiments of the present invention may be configured for any appropriate address designation. Also, while the AODV network 400 illustrates five (5) nodes and one (1) node (i.e., node 2) having a connection to the Internet 430, it is understood that other example embodiments of the present invention may be directed to AODV networks having any number of nodes and also with any number of nodes having Internet connections.

Further, while example embodiments of the present invention are described above as being applied within an AODV routing protocol, it is understood that other example embodiments may be directed to any type of routing protocols for Mobile Ad-Hoc Network (MANET), and is not necessarily limited to AODV.

Such variations are not to be regarded as a departure from the example embodiments of the invention, and all such modifications are intended to be included within the scope of the invention.

We claim:

1. A method of routing data, comprising:
receiving a data packet at a communication node, the communication node including connections to an Internet and at least one other communication node not connected the Internet, each of the communication node and the at least one other communication node included within a same Mobile Ad-Hoc Network (MANET);
determining whether the data packet is configured to be sent to one of the Internet and the at least one other communication node; and
sending the data packet to one of the Internet and the at least one other communication node based on the determining step.

2. The method of claim 1, wherein the receiving step receives the data packet from the at least one other communication node.

3. The method of claim 2, wherein the determining step determines that the data packet is configured to be sent to the Internet.

4. The method of claim 3, wherein the sending step sends the data packet to the Internet.

5. The method of claim 1, wherein the receiving step receives the data packet from the Internet.

6. The method of claim 5, wherein the determining step determines that the data packet is configured to be sent to the at least one other communication node.

7. The method of claim 6, wherein the sending step sends the data packet to the at least one other communication node.

8. The method of claim 1, wherein the MANET running Ad-hoc On-demand Distance Vector (AODV) routing protocol.

9. A method of routing data from a source node without an Internet connection to an Internet destination entity, comprising:
sending a data packet from the source node to a gateway node having an Internet connection, the source node and the gateway node within a same Mobile Ad-Hoc Network (MANET), the data packet including instructions instructing the gateway node to forward the data packet to the Internet destination entity through the Internet connection.

10. The method of claim 9, wherein the MANET is running Ad-hoc On-demand Distance Vector (AODV) routing protocol.

11. A method of routing data from an Internet source entity to a destination node without an Internet connection, comprising:
sending a data packet to a gateway node having an Internet connection and connected to the destination node, the gateway node and the destination node within a same Mobile Ad-Hoc Network (MANET), the data packet including instructions instructing the gateway node to forward the data packet to the destination node.

12. The method of claim 11, wherein the MANET is running Ad-hoc On-demand Distance Vector (AODV) protocol.

13. A wireless communication system, comprising:
an Internet connection connected to a plurality of communication networks; and
a Mobile Ad-Hoc Network (MANET) included among the plurality of communication networks, the MANET including at least one node connected to the Internet connection, the at least one node configured to route data packets between the plurality of communication networks and nodes within the MANET which are not connected to the Internet connection.

14. The method of claim 13, wherein the MANET is running Ad-hoc On-demand Distance Vector (AODV) routing protocol.

15. A method of routing data between a Mobile Ad-Hoc Network (MANET) and one or more other networks, comprising:
first assigning each node within the MANET an internal address; and
second assigning the MANET an external address, the external address distinguishing the MANET from the one or more other networks.

16. The method of claim 15, wherein the MANET is running Ad-hoc On-demand Distance Vector (AODV) routing protocol.

17. The method of claim 15, further comprising:
designating one node or more nodes within the MANET as an Internet gateway, the designated node(s) receiving packets either (i) sent from the one or more other networks to the MANET or (ii) sent from the MANET to the one or more other networks.

18. The method of claim 17, further comprising:
analyzing the received packets at the designated node to determine whether to forward the received packets to another node within the MANET; and
forwarding the received packets in accordance with the analyzing step.

19. The method of claim 17, further comprising:
analyzing the received packets at the designated node to determine whether to forward the received packets to the one or more other networks; and
forwarding the received packets in accordance with the analyzing step.
